(19) United States
(12) Patent Application Publication
(10) Pub. No.: US 2025/0108487 A1
(43) Pub. Date: Apr. 3, 2025

(54) Clamp with Movement Management

(71) Applicant: Stanley Black & Decker, Inc., New Britain, CT (US)

(72) Inventors: Robin E. Smith, Stanley, NC (US); Ralf Strauss, Stanley, NC (US)

(21) Appl. No.: 18/655,234

(22) PCT Filed: Nov. 3, 2022
(86) PCT No.: PCT/US2022/048831

§ 371 Date: May 4, 2024

Related U.S. Application Data
(60) Provisional application No. 63/275,915, filed on Nov. 4, 2021.

(51) Int. Cl. B25B 5/10; B25B 5/16

(52) U.S. Cl. CPC B25B 5/102; B25B 5/16

(57) ABSTRACT

A clamp includes a bar having top and bottom surfaces, a fixed jaw fixed to the bar, and a movable assembly movable along the bar. The movable assembly includes a movable jaw, an actuator that incrementally moves the movable assembly to apply a clamp force to a clamp load, a release lever to disengage the movable assembly to release a clamp force and permit free sliding of the movable assembly along the bar. The movable assembly may support a bearing surface formed of a low-friction material, positioned to prevent the movable assembly from binding to the bar when a clamp load is released. The release lever may be movable between a position engaging the bar, a position where the release lever disengages the bar, and another position engaging the bar, the third position being opposite the first position with the second position therebetween.

### CROSS REFERENCE TO RELATED APPLICATIONS

The present invention claims priority to U.S. Provisional Patent Application Ser. No. 63/275,915, filed on Nov. 4, 2021, which is incorporated herein by reference in its entirety.

### FIELD OF THE INVENTION

The present invention relates generally to hand tools, and more particularly to clamps or spreaders.

### BACKGROUND OF THE INVENTION

Various tools configured to clamp and/or spread against surfaces, are known. Among other things, the present application relates to various improvements to such clamping or spreading tools, which may be used for holding together or spreading apart workpieces such as woodworking constructions, cabinets, doors, windows, framing segments, pallets, and so on. As used herein, the term clamp may be understood as generically referring to tool that may be used to move a jaw to pull into a workpiece (e.g., for clamping) or to a tool that moves a jaw to push against a workpiece (e.g., for spreading), or to a tool that may be configurable to do either pulling into or pushing against a workpiece (e.g., by changing an orientation of components thereof). This disclosure includes various improvements which may be utilized together or independently in various embodiments. Some known clamps utilize pull triggers to move an engaging assembly along a bar. Other known clamps utilize a screw mechanism (e.g., in an F-clamp). Still other known tools are hybrid clamps, which combine features of a screw clamp and a trigger clamp. The present disclosure includes various improvements to clamps, which may be utilized together or independently in various embodiments, in trigger clamps or hybrid clamps.

### SUMMARY OF THE INVENTION

According to an embodiment, a clamp includes a bar having a top surface and a bottom surface, a fixed jaw fixed relative to the bar, and a movable assembly configured to selectively move along the bar. The movable assembly includes a movable jaw positioned to move with the movable assembly relative to the fixed jaw, an actuator configured to incrementally move the movable assembly along the bar towards the fixed jaw and to apply a clamp force to a clamp load, a release lever configured to disengage the movable assembly from the bar to permit free sliding of the movable assembly along the bar towards or away from the fixed jaw, and to release a clamp force when actuated; and a bearing surface formed of a low-friction material, supported in the movable assembly, and positioned to prevent the movable assembly from binding to the bar when a clamp load is released through actuation of the release lever.

According to another embodiment, a clamp includes a bar having a top surface and a bottom surface, a fixed jaw fixed relative to the bar; and a movable assembly configured to selectively move along the bar. The movable assembly includes a movable jaw positioned to move with the movable assembly relative to the fixed jaw, an actuator configured to incrementally move the movable assembly along the bar towards the fixed jaw and to apply a clamp force to a clamp load, and a release lever configured to disengage the movable assembly from the bar to permit free sliding of the movable assembly along the bar towards or away from the fixed jaw, and to release a clamp force when actuated. The release lever is movable between a first position engaging the bar, a second position where the release lever disengages the bar to permit the movable assembly to freely slide along the bar, and a third position engaging the bar, the third position being opposite the first position with the second position therebetween.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

Features of clamps in accordance with one or more embodiments are shown in the drawings, in which like reference numerals designate like elements. The drawings form part of this original disclosure in which:

FIG. 1 illustrates a perspective view of an embodiment of a clamp of the present disclosure;

FIG. 2 illustrates a side cross sectional view of the clamp of FIG. 1, alongside the length of a bar thereof;

FIG. 3 illustrates an enlarged perspective view of the clamp of FIG. 1 with a cover of a housing removed to view an interior of a movable assembly thereof including bearing surfaces according to an embodiment, said bearing surfaces shown in isolation in insert FIG. 3A.

FIG. 4 illustrates an enlarged side view of the clamp of FIG. 1 with the cover removed, with a release lever in a first position;

FIG. 5 repeats the enlarged side view of the clamp from FIG. 4, with the release lever in a second position; and

FIG. 6 repeats the enlarged side view of the clamp from FIGS. 4 and 5, with the release lever in a third position.

### DETAILED DESCRIPTION OF THE ILLUSTRATED EMBODIMENT(S)

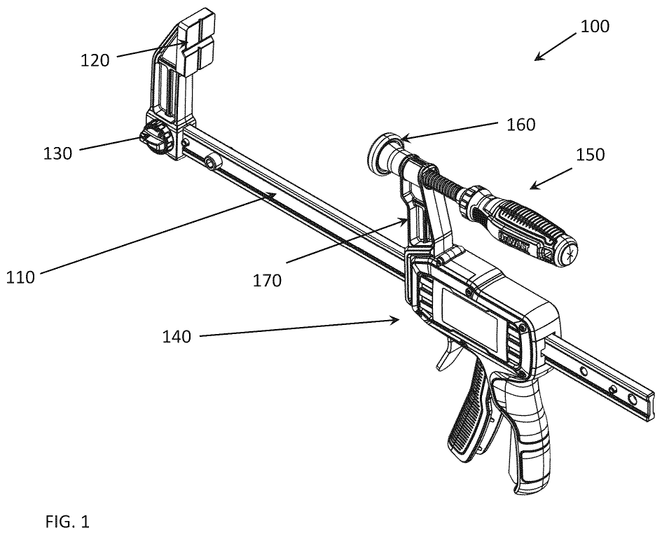

FIG. 1 illustrates a perspective view of an embodiment of a clamp 100 of the present disclosure. The clamp 100 includes a bar 110, onto which is mounted a fixed jaw 120. The bar 110 and the fixed jaw 120 may be conventional in some embodiments. In an embodiment, the fixed jaw 120 may be removably mounted to the bar 110, and may be removed or repositioned on the bar 110 through actuation of a fixed jaw release 130. The clamp 100 further includes a movable assembly 140 configured to move along the bar 110 as described herein. As shown, in the illustrated embodiment the clamp 100 is a hybrid clamp, and as such, besides for the movable assembly 140 being configured to move along the bar 110, the movable assembly 140 includes a screw clamp assembly 150 including a screw clamp jaw 160 mounted to the remainder of the movable assembly 140 via a screw clamp mount 170.

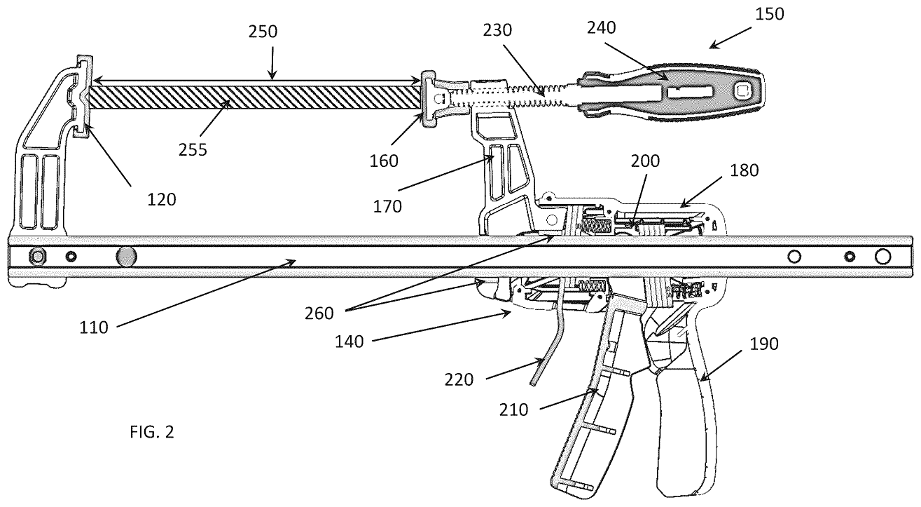

Additional details of the clamp 100 may be seen in FIG. 2, which illustrates a side view of the clamp 100 cross sectioned along the length of the bar 110. As shown, the movable assembly 140 includes a housing 180, which may include a handle 190 extending from or formed therewith. The movable assembly 140 also includes a trigger clamp mechanism 200, which selectively engages and moves the movable assembly 140 along the bar 110. The trigger clamp mechanism is discussed in greater detail below; however, it may be appreciated that the mechanism 200 may include an actuator 210 (e.g., a trigger) and a release lever 220 in some embodiments. Actuation of the actuator 210 by pulling it towards the trigger clamp mechanism handle 190 formed in or extending from the housing 180 for the trigger clamp mechanism 200 causes movement of the trigger clamp mechanism 200, along the bar 110, and as such moves the movable assembly 140 including the screw clamp assembly 150 extending therefrom on the screw clamp mount 170, such that a screw clamp jaw 160 of the screw clamp assembly may clamp a load against the fixed jaw 120.

As additionally shown, the screw clamp assembly 150 may include a screw clamp shaft 230 coupling the screw clamp jaw 160 to a screw clamp handle 240. Once at a desired position clamping a load between the screw clamp jaw 160 and the fixed jaw 120, further clamping force may be applied by twisting the screw clamp assembly 150 so that shaft threads 230a on a screw clamp shaft 230 between the screw clamp handle 240 and the screw clamp jaw 160 engage mount threads 170a on the screw clamp mount 170, such that rotation of the screw clamp handle 240 may advance or retreat the screw clamp jaw 160 relative to the screw clamp mount 170, which may further move the screw clamp jaw 160 towards the fixed jaw 120 or otherwise relative to the bar 110. Likewise, fine tuning of the clamp force may be performed by twisting the screw clamp assembly 150 to move the screw clamp jaw 160 slightly away from the fixed jaw 120 by turning the screw clamp handle 150 in an opposite direction, unscrewing the screw clamp shaft 230 relative to the movable assembly 140

In some embodiments, such as that shown, the screw clamp jaw 160 may be pivotally and/or rotatably mounted on the screw clamp shaft 230, so that desired engagement between the screw clamp jaw 160 and a workpiece may be achieved. As shown, through movement of the movable assembly 140 along the bar 110 towards the fixed jaw 120, and through further movement of the screw clamp jaw 160 towards the fixed jaw 120, a desired clamp force 250 may be achieved between the fixed jaw 120 and the screw clamp jaw 160 by squeezing against a clamp load 255 (which could comprise one or more objects secured between the fixed jaw 120 and the screw clamp jaw 160).

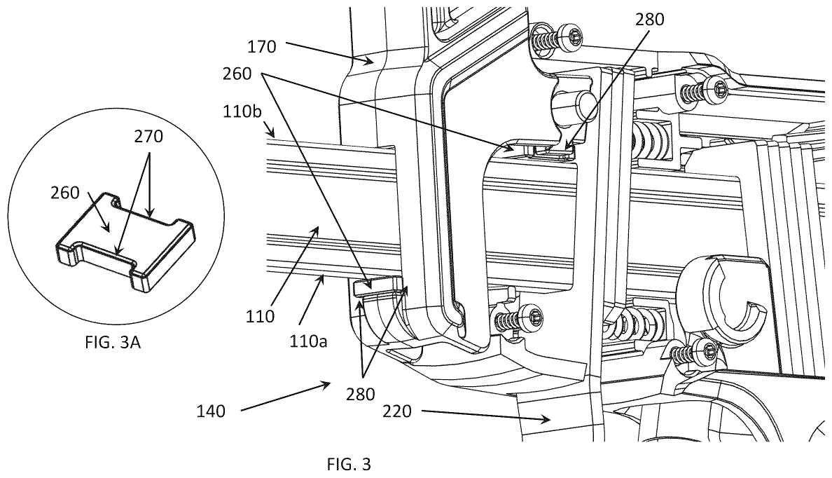

Further shown in FIG. 2, and as enlarged in FIG. 3 and shown in isolation in FIG. 3A, the clamp 100 may utilize a bearing surface (e.g., one or more bearings 260) to mitigate or prevent jaw binding. It may be appreciated that while incremental movement of the trigger clamp mechanism 200 is actuated via the actuator 210, release of a clamp force (or ability to slide the movable assembly 140 freely along the bar) is actuated by a release lever 220. Jaw binding may occur at any point during movement between the movable assembly 140 of the clamp 100 and the bar 110 of the clamp 100, as discussed in greater detail below, including but not limited to when a clamp force 250 is released (e.g., when the clamp 100 is applying a clamp force 250 to a clamped load 255, and the clamp force 250 is released through actuation of the release lever 220).

When a clamp force 250 is applied between the fixed jaw 120 and the screw clamp jaw 160, and in particular when a further screw clamp force has been applied on top of the trigger clamp force formed from the trigger clamp mechanism 200, a binding force may form on opposing sides of the trigger clamp mechanism 200 where it engages the bar 110, proximal to where the screw clamp mount 170 meets the bar 110. As described herein, the bearings 260 positioned at these points of contact between the bar 110 and the movable assembly 140 may be configured to prevent the movable assembly 140 from binding to the bar 110 when the clamp force is released through the release lever 220 of the trigger clamp mechanism 220.

In an embodiment, the bearings 260 may be low-friction bearings. In some embodiments, the bearings 260 may be formed of a polymer, such as but not limited to polytetrafluoroethylene (PTFE), high-density polyethylene (HDPE), or ultra-high molecular weight (UHMW) polyethylene material. In an embodiment the bearing 260 may be formed of an oil impregnated material such as oil impregnated sintered bronze, or may otherwise be lubricated or self-lubricating. In some embodiments, the oil impregnated material may be that sold under the trade name Oilite® or may be formed from a similar material. It may be appreciated that such bearings 260 may have a desired compressive strength and a desired low coefficient of friction so as to deter binding of the movable assembly 140 to the bar 110.

FIG. 3 illustrates an enlarged view of the movable assembly 140, with a cover portion of the housing 180 omitted to reveal the trigger clamp mechanism 200 therein. As shown, in some embodiments bearings 260 may be positioned between the bar 110 and the remainder of the movable assembly 140. For example, in an embodiment a bearing 260 may be below the bar 110 (e.g., to contact a bottom surface 110a thereof), opposite the screw clamp mount 170 as it extends above the bar 110 (e.g., at a top surface 110b thereof). In an embodiment, a bearing 260 may be positioned on top of the bar 110 (e.g., at the top surface 110b), adjacent to where the release lever 220 engages the bar 110. In some embodiments, the screw clamp mount 170 may extend from a larger piece or assembly formed from a low-friction material that serves as the low friction bearings 260. In an embodiment, the screw clamp mount 170 including the regions of the movable assembly 140 forward of the release lever 220 that surround the bar 110 may be formed from such low-friction materials to serve as the low-friction bearings 260.

In embodiments where the bearings 260 are separate pieces assembled into the movable assembly 140, they may be shaped appropriately to be received in the movable assembly 140. For example, inset FIG. 3A in FIG. 3 illustrates an embodiment of one of the bearings 260 of the illustrated embodiment, having alignment features 270 that permit being received into or receiving corresponding alignment features 280 of the movable assembly 140.

According to another aspect of the present disclosure, in some embodiments the clamp 100 may be configured with a bar jump mitigation mechanism, as described below. As indicated above, while the clamp 100 is illustrated as a hybrid clamp, it may be appreciated that the bar jump mitigation mechanism may be implemented on other clamp configurations. Regardless, it may be appreciated that when a clamp 100 has applied a clamping force 250 to a load 255 held between a movable jaw (e.g., the screw clamp jaw 160 of the illustrated embodiment) and the fixed jaw 120, release of such a clamping force, such as by the release lever 220, may normally cause one or more of the movable assembly 140 and the fixed jaw 120 (as fixed to the bar 110) to quickly jump or speed away from the load 255. Depending on whether the fixed jaw 120 is itself braced against a surface, or if the movable assembly 140 is strongly held by a user, the movement may occur with the bar 110 and fixed jaw 120 moving away from the movable assembly 140 being held in a relatively fixed position, or may occur with the movable assembly 140 jumping away from the fixed jaw 120 along the bar 110, thus jerking a user's engaging hand at the same time.

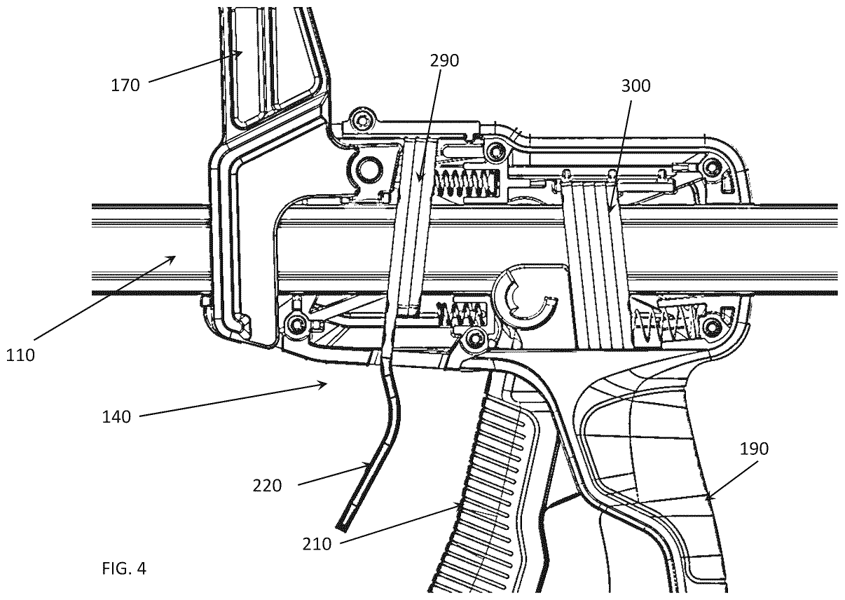

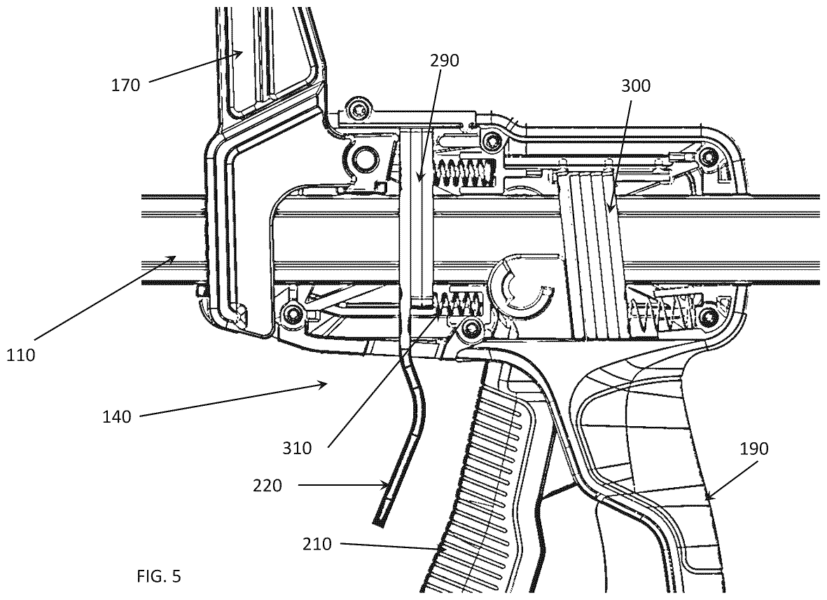

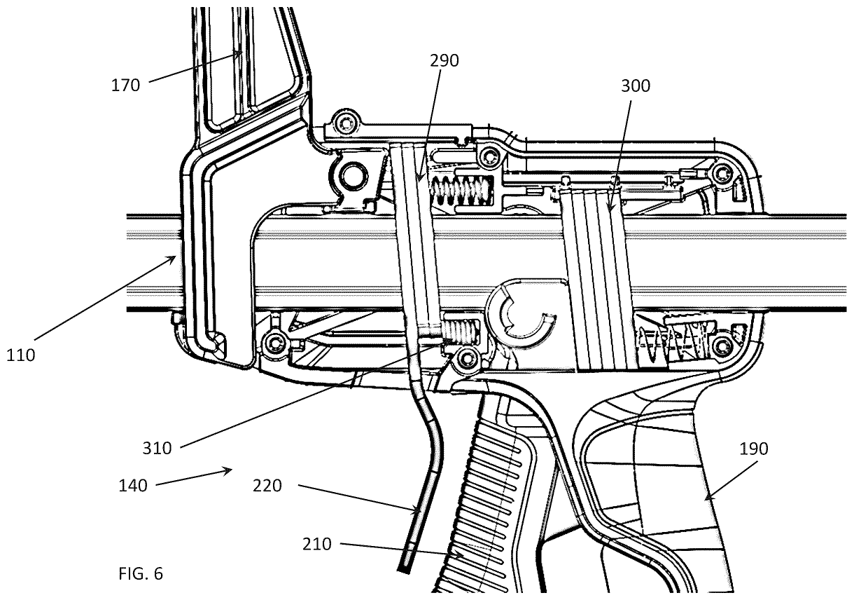

As shown in FIGS. 4-6, a bar jump mitigation mechanism may be provided on the bar clamp 100, such as in the trigger clamp mechanism 200, and may be configured to act as a brake on the movable assembly 140 to hold the movable assembly 140 and the bar 110 relative to one another in a controlled manner as the clamp force is released by actuation of the release lever 220, to mitigate the jumping movement between the bar 110 (and the fixed jaw 120 mounted thereto) and the movable assembly 140. In particular, the release lever 220 may be configured to pivot relative to the bar 110 and move between three notable positions, each shown in one of FIG. 4, FIG. 5, and FIG. 6.

FIG. 4 illustrates the bar clamp 100 in a clamping position, where brake plates 290 (also known as brake tabs) are in a first position angled relative to the bar 110 to prevent the movable assembly 140 and the fixed jaw 120 from moving apart (e.g., away from one another) by gripping onto the bar 110. While actuation of the actuator 210 by pulling it towards the trigger clamp mechanism handle 190 would move clamp plates 300 so as to incrementally grab onto the bar 110 to walk the movable assembly 140 along the bar 110 towards the fixed jaw 120, when unactuated as shown in FIG. 4, a load 255 may be clamped between the movable assembly 140 and the fixed jaw 120, applying an outward force that is arrested by the brake plates 290.

Moving to FIG. 5, when a user actuates the release lever 220, the brake plates 290 are moved into a second position to create a gap between the brake plates 290 and the bar 110, such that the bar 110 may move freely relative to the movable assembly 140. In this position, when a force has been previously clamped between the movable assembly 140 and the fixed jaw 120, such relative movement from the release of the clamping force will start to cause relative movement between the bar 110 and the movable assembly 140. As further shown in FIG. 5, in the second position the release lever 220 may have disengaged from the bar 110, however would have not yet engaged a jump mitigation spring 310, described in greater detail below, in some such embodiments.

Finally, as shown in FIG. 6, the release lever 220 may be further pulled so that the brake plates 290 are in a third position, angled opposite of where they would be in the clamping position of FIG. 4. It may be appreciated that some effort is required to pull the release lever 220 to overcome the clamp force when applied, as would be the case in FIG. 4, and as such, when a user pulls on the release lever 220 with such sufficient force to release the clamping, the brake plates 290 would move through their second position of FIG. 5 that allows free movement of the movable assembly 140 relative to the bar 110, and into the third position, an opposing brake position, to again prevent movement of the movable assembly 140 relative to the bar 110. It may thus be appreciated that movement of the movable assembly 140 relative to the bar 110, and in particular the sudden jumping movement, would be slowed or arrested as the user further squeezes on the release lever 220 relative to a trigger clamp mechanism handle 190 of the movable assembly 140, as such force would not tend to result in only moving the release lever 220 from the first position to the second position.

As further shown in FIG. 6, in some embodiments the jump mitigation spring 310 may be actuated with such a force overcoming pull of the release lever 220 (e.g., a compression spring being compressed in the illustrated embodiment). As such, it may be appreciated that once the clamp force has been released, the jump mitigation spring 310 may bias the release lever 220, when actuated not under a clamping force, to tend to result in moving the release lever 220 from the first position to the second position, and deter further movement into the third position, so that sliding movement of the movable assembly 140 relative to the bar 110 may be easily accomplished (e.g., for gross adjustment of a spacing between the movable jaw (e.g., the screw clamp jaw 160 and the fixed jaw 120).

It may be appreciated that any appropriate spring forces may be utilized on the jump mitigation spring 310, or on the angles of the brake plates 290 as they interface with the bar 110, to provide a desired braking of the relative movement of the movable assembly 140 and the bar 110, and create a desired user feedback from actuation of the release lever 220 to release the clamp force or permit free movement of the movable assembly relative to the bar.

The objects, features, and characteristics of the present invention, as well as the methods of operation and functions of the related elements of structure and the combination of parts and economies of manufacture, may be apparent upon consideration of the description and drawings herein, all of which form a part of this specification, In one embodiment of the invention, the structural components illustrated herein are drawn to scale.

It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used herein, the singular form of “a”, “an”, and “the” include plural referents unless the context clearly dictates otherwise.

In various embodiments, the hybrid clamp described herein may be formed from metal, plastic, ceramic, wood, or any other appropriate material, or combinations of such materials. It may be appreciated that the components described herein may be of different constructions or configurations, including but not limited to one or more being comprised of different material choices. For example, various components described herein may each be constructed from a variety of materials, including but not limited to one or more of fabrics, plastics, metals, rubbers, elastomers, or any other appropriate material choice, such as aluminum (e.g., machined aluminum), iron (e.g., steel), ceramic, or any other appropriate material. In addition, portions of tools leveraging the above teachings may be formed from molded plastic, metal, or combinations thereof (e.g., plastic with metal supports or fasteners coupling portions together). In some embodiments, structural and functional components may be formed from metal or hard plastic, while exterior-most gripped components positioned to engage the palm of a gripping hand to provide the palm with a comfortable gripping surface may be made of a suitable molded plastic material or elastomeric material, and may be generally formed as a bi-material suitable molded plastic material coated with a layer of an elastomeric material, such as a rubber-based material. In some embodiments, the material choices may differ from component to component. In various embodiments, some components may be integrally formed together, while other components may be assembled by any appropriate mechanism, including but not limited to fastened, welded, snap-fit, friction fit, adhesive bonding, or other appropriate securements.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope inventions more specifically understood in the context of the above disclosure.

What is claimed is:

1. (canceled)

2. The clamp of claim 18, wherein the bearing surface is formed of a polymer.

3. The clamp of claim 2, wherein the bearing surface is formed of one or more of PTFE, HDPE, or UHMW polyethylene.

4. The clamp of claim 8, wherein the bearing surface is formed of an oil impregnated material.

5. The clamp of claim 4, wherein the bearing surface comprises sintered bronze.

6. The clamp of claim 8, wherein the bearing surface is positioned to contact the bottom surface of the bar, opposite a mount for the movable jaw.

7. The clamp of claim 8, wherein the bearing surface is positioned to contact the top surface of the bar, adjacent to an engagement point between the release lever and the bar.

8. A clamp comprising:
a bar having a top surface and a bottom surface;
a fixed jaw fixed relative to the bar; and
a movable assembly configured to selectively move along the bar, the movable assembly comprising:
a movable jaw positioned to move with the movable assembly relative to the fixed jaw;
an actuator configured to incrementally move the movable assembly along the bar towards the fixed jaw and to apply a clamp force to a clamp load;
a release lever configured to disengage the movable assembly from the bar to permit free sliding of the movable assembly along the bar towards or away from the fixed jaw, and to release a clamp force when actuated; and
a bearing surface formed of a low-friction material, supported in the movable assembly, and positioned to prevent the movable assembly from binding to the bar when a clamp load is released through actuation of the release lever;
wherein the bearing surface is formed on a bearing insert that is received in the movable assembly, and includes alignment features to support and hold the bearing insert in the movable assembly.

9. The clamp of claim 8, wherein the movable assembly comprises a screw clamp assembly including a screw clamp handle, and wherein the movable jaw is a screw clamp jaw configured to separately move relative to the fixed jaw through rotation of the screw clamp handle.

10. A clamp comprising:
a bar having a top surface and a bottom surface;
a fixed jaw fixed relative to the bar; and
a movable assembly configured to selectively move along the bar, the movable assembly comprising:
a movable jaw positioned to move with the movable assembly relative to the fixed jaw;
an actuator configured to incrementally move the movable assembly along the bar towards the fixed jaw and to apply a clamp force to a clamp load;
a release lever configured to disengage the movable assembly from the bar to permit free sliding of the movable assembly along the bar towards or away from the fixed jaw, and to release a clamp force when actuated; and
a bearing surface formed of a low-friction material, supported in the movable assembly, and positioned to prevent the movable assembly from binding to the bar when a clamp load is released through actuation of the release lever;
wherein the release lever is movable between a first position engaging the bar, a second position where the release lever disengages the bar to permit the movable assembly to freely slide along the bar, and a third position engaging the bar, the third position being opposite the first position with the second position therebetween.

11.-20. (canceled)

21. The clamp of claim 10, wherein the bearing surface is formed of a polymer.

22. The clamp of claim 21, wherein the bearing surface is formed of one or more of PTFE, HDPE, or UHMW polyethylene.

23. The clamp of claim 10, wherein the bearing surface is formed of an oil impregnated material.

24. The clamp of claim 23, wherein the bearing surface comprises sintered bronze.

25. The clamp of claim 10, wherein the bearing surface is positioned to contact the bottom surface of the bar, opposite a mount for the movable jaw.

26. The clamp of claim 10, wherein the bearing surface is positioned to contact the top surface of the bar, adjacent to an engagement point between the release lever and the bar.

27. The clamp of claim 10, wherein the movable assembly comprises a screw clamp assembly including a screw clamp handle, and wherein the movable jaw is a screw clamp jaw configured to separately move relative to the fixed jaw through rotation of the screw clamp handle.
